(19) United States
(12) Patent Application Publication
(10) Pub. No.: US 2014/0323218 A1
(43) Pub. Date: Oct. 30, 2014

(54) SYSTEMS AND METHODS FOR GAME PERIPHERALS

(71) Applicant: OTHMAN R. SULEIMAN, Boynton Beach, FL (US)

(72) Inventor: OTHMAN R. SULEIMAN, Boynton Beach, FL (US)

(21) Appl. No.: 13/871,046

(22) Filed: Apr. 26, 2013

(51) Int. Cl. A63F 13/02

(52) U.S. Cl. CPC A63F 13/02
USPC 463/36

(57) ABSTRACT

In accordance with one embodiment, a portable system is provided. The portable system enabling the portable system's peripherals or built-in gadgets as gaming system peripherals. The portable system is enabled to electrically connect to the one or more of peripheral or the built-in gadgets. The portable system further comprises an instruction set to couple the gaming system and the portable system. The instruction set is stored on a non-volatile portable system memory. The instruction set further enables pairing of the gaming system with at least one of the portable system peripherals or built-in gadgets.

### BACKGROUND OF THE INVENTION

1. Field of the Invention

Embodiments of the present invention generally relate to video game consoles, and more particularly to systems and methods for interfacing video game consoles using a mobile phone.

2. Description of the Related Art

The continual advancement of digital connectivity is evident in the field of computer based gaming. As video games advanced, the prices of associated electronics and controls have increased rapidly. Generally, video gaming systems include a console system or core unit that includes a processor, memory (e.g., Random Access Memory), and audio visual subsystems such as a co-processor. The console system serves as a hub between the video display or monitor, various controllers (e.g., joy sticks and other user interface devices), and external memory devices containing the game software.

Originally, game controllers were typically wired to the console and were designed to send input signals to the console system over the wired connection. In recent times, wireless game controls have emerged. The wireless game controls allow for a user not to be tethered to the console system. The wireless game controls were generally designed to be compatible with a single console system. In recent times, individuals utilize many mobile and/or wireless devices in their everyday lives. These devices include multiple remote controls, lap top computers, cell phones, smart phones, Personal Digital Assistants (PDAs), and other mobile devices. The ever increasing number of these devices can be overwhelming and frustrating.

Adding a wireless game controller to this already large list of devices adds to the gamer's expense. It would be advantageous to better utilize the existing mobile devices instead of adding another wireless device dedicated to controlling a video game console system.

Moreover, contemporary video game trend has focused on player-to-player interactions within the virtual world. Massively multi-player online games (MMOG) are capable of supporting over thousands of players in a single virtual environment. However, these games are typically played by individuals who are physically remote from each other, thereby removing the fun and pleasure that one experience when other players are physically present. With regard to multi-player video games that are played by players who are physically present with each other, actual personal interaction outside of the virtual game environment during game play is not required.

In view of the foregoing, there is a need in the art for improved systems and/or methods for facilitating the game play experience of individuals with each other.

### SUMMARY

In accordance with one embodiment, a portable system is provided. The portable system enables a user to be able to use the peripherals or built-in gadgets of the portable system as a gaming system peripherals. The portable system and the gaming system are connect to send and receive data and commands between the portable system and the gaming system. Furthermore, the portable system is electrically connected to one or more of peripheral or the built-in gadgets.

The portable system further comprises an instruction set stored on a non-volatile portable system memory. The instruction set may be a high level or a low level computer code. The portable system uses instruction set to enable coupling the gaming system and the portable system. The same instruction set may further have code required to pair the gaming system with at least one of the portable system peripherals or built-in gadgets.

In one embodiment, the system may have one or more intermediary gadget acting as a mediator between the gaming system and the portable system. The gadget may be a specialized electromechanical device configured to physically couple with the gaming system. The intermediary gadget may allow to circumvent manufacturer created limitation of the gaming system to communicate or pair with the non-original equipment manufacturer (OEM) peripherals. For example, the intermediary gadgets may enable gaming system communicate with the portable system using the instruction set.

In one embodiment, the portable system may be a cellphone. The plurality of peripherals or the built-in gadgets enabling communication of at least one of audio, visual, mechanical, sensory signals to and from the gaming system via the portable system. The system may also include a user interface enabling a user and the portable system to interact. The user interface may use the instruction set to provide controls for managing the plurality of peripherals or the plurality of built-in gadgets.

In accordance with one embodiment, at least one of the peripheral or built-in gadgets is a headset with at least one speaker and a microphone built-in. In yet another embodiment, the instruction set is an integral part of a mobile software application. The portable system pairs with the gaming system using one of a wired or wireless technology. Alternatively, the portable systems keypad is used to communicate instructions between the portable system and the gaming system.

In accordance with one embodiment, a method enables a portable system's peripherals or built-in gadgets to act as gaming system peripherals. The methods electrically connects the portable system to the plurality of peripherals or the built-in gadgets. The method may also provide pairing the gaming system and the portable system using an instruction set stored on a non-volatile portable system memory, the instruction set further enabling pairing of the gaming system with at least one of the portable system peripherals or built-in gadgets.

The method may also include enabling communication of at least one of audio, visual, mechanical, sensory signals to and from the gaming system. The method may provide a user interface enabling a user and the portable system to interact, such that the user interface uses the instruction set.

The method may further include managing the plurality of peripherals or the plurality of built-in gadgets using the user interface. The method may use the user interface for controlling the relationship between the plurality of peripherals or the plurality of built-in gadgets and the gaming system.

In one embodiment, the method may provide at least one of the peripheral or built-in gadgets as a headset with at least one speaker and a microphone built-in. The method integrating the instruction set within a mobile software application. The method pairing the portable system with the gaming system using one of a wired or wireless technology.

In addition, the method involves using the portable systems keypad to communicate instructions between the portable system and the gaming system. The method further enabling multiple players communicate with each other using the peripheral or built-in gadgets.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a portable system's peripherals or built-in gadgets being used as gaming system peripherals in accordance with an embodiment.

FIG. 2 illustrates a block diagram of a portable system 100 in accordance with an embodiment.

FIG. 3 illustrates a process/method 300 for enabling a portable system's peripherals or build-in gadgets to acts as gaming system 20 peripherals in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

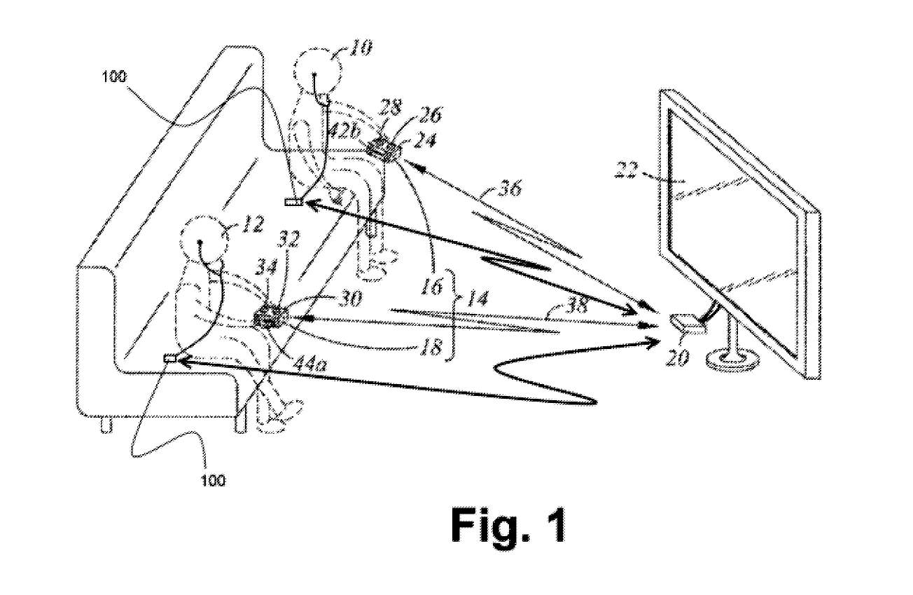

FIG. 1 illustrates an exemplary environment including a first and a second user (10, 12) as interacting with a multi-player game controller system 14. The multi-player game controller system 14 includes a first hand-held game controller 16 as being used by the first user 10 and a second hand-held game controller 18 as being used by a second user 12. As will be further described below the first and second hand-held game controllers 16, 18 are in an unengaged state. There is also illustrated a gaming system 20 and a display device 22.

The first hand-held game controller 16 includes a first game controller housing 24, and a first input control, such as a knob 26 or a button 28, attached to the first game controller housing 24. The first input control is configured to generate a first input control signal 36 in response to interaction with the first user 10. The first and second hand-held game controllers 16, 18 have engagement states of an engaged state and an unengaged state. The first and second game controllers 16, 18 are in fixed physical relation to each other with respect to at least one degree of freedom when in the engaged state. The first and second hand-held game controllers 16, 18 are independently movable in relation to each other when in the unengaged state.

The second hand-held game controller 18 includes a second game controller housing 30, and a second input control, such as a knob 32 or a button 34, attached to the second game controller housing 30. The second input control 18 is configured to generate a second input control signal 38 in response to interaction with a second user 12. The engagement circuitry 46 is configured to generate an engagement signal 40 in response to the first and second hand-held game controllers 16, 18 being in the engagement state.

As shown in FIG. 1, a portable system's 100 peripherals gadgets 102 or built-in gadgets (not shown) being used as gaming system peripherals. The first user and the second user (10, 12) are engaged with the gaming system 20. For example, as shown in FIG. 1, the first user and the second user (10, 12) may be using the headset that is a peripheral of the portable system 100. It is to be understood that the embodiments and features that are described herein may be implemented by hardware, software, firmware or any combination thereof.

In one embodiment, the portable system 100 may have one or more intermediary gadget to help the portable system to connect to the gaming system 20. The intermediary gadget may allow to circumvent limitation of the gaming system 20 to communicate or pair with the non-original equipment manufacturer (OEM) peripherals. For example, the intermediary gadgets may be one connected directly to the gaming system 20 or to a hand-held game controllers 16, 18. The intermediary gadget may enable gaming system 20 to communicate with the portable system 100.

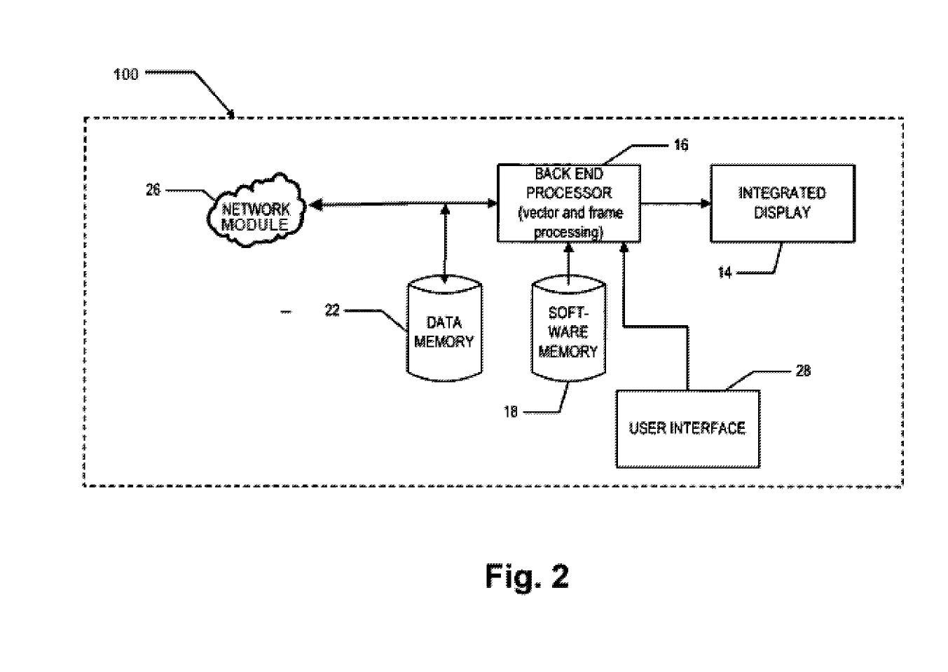

FIG. 2 illustrates a block diagram of a portable system 100 in accordance with an embodiment. Software or firmware memory 18 can comprise a read only memory (ROM), random access memory (RAM), a miniature hard drive, a flash memory card, or any kind of device (or devices) configured to read instruction set from a machine-readable medium or media. The portable system 100 further comprises an instruction set to couple the gaming system 20 and the portable system 100. The instruction set is stored on a non-volatile portable system memory. The instruction set contained in software or firmware memory 18 further include instruction set to pair the gaming system 20 with at least one of the portable system 100 peripherals or built-in gadgets.

Network module may enable data sent from portable system to external device 24 via a wired or wireless network (or direct connection, for example, via a serial or parallel cable or USB port) 26 under control of processor 16 and user interface 28. In some embodiments, external device 24 may be a computer or a workstation having a display. In some other embodiments, external device 24 may be a gaming system 20.

A user interface 28 (that may also include integrated display 14) is provided to receive commands from a user and to instruct back end processor 16 to perform certain functions that may enhance users experience engaging with a gaming system 20. Various embodiments described herein are described in the general context of methods or processes, which may be implemented in one embodiment by a computer program product, embodied in a computer-readable medium, including computer-executable instructions, such as program code, executed by computers in networked environments.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

For example, the portable system 100 may be a cellphone. The plurality of peripherals or the built-in gadgets enabling communication of at least one of audio, visual, mechanical, sensory signals to and from the gaming system 20 via the portable system 100. The system may also include a user interface enabling a user and the portable system 100 to interact. The user interface may use the instruction set installed or stored on the portable system 100. The user interface may provide controls for managing the plurality of peripherals or the plurality of built-in gadgets.

In accordance with one embodiment, at least one of the peripheral or built-in gadgets is a headset with at least one speaker and a microphone built-in. In yet another embodiment, the instruction set is an integral part of a mobile software application. The portable system 100 pairs with the gaming system 20 using one of a wired or wireless technology. Alternatively, the portable systems keypad is used to communicate instructions between the portable system 100 and the gaming system 20.

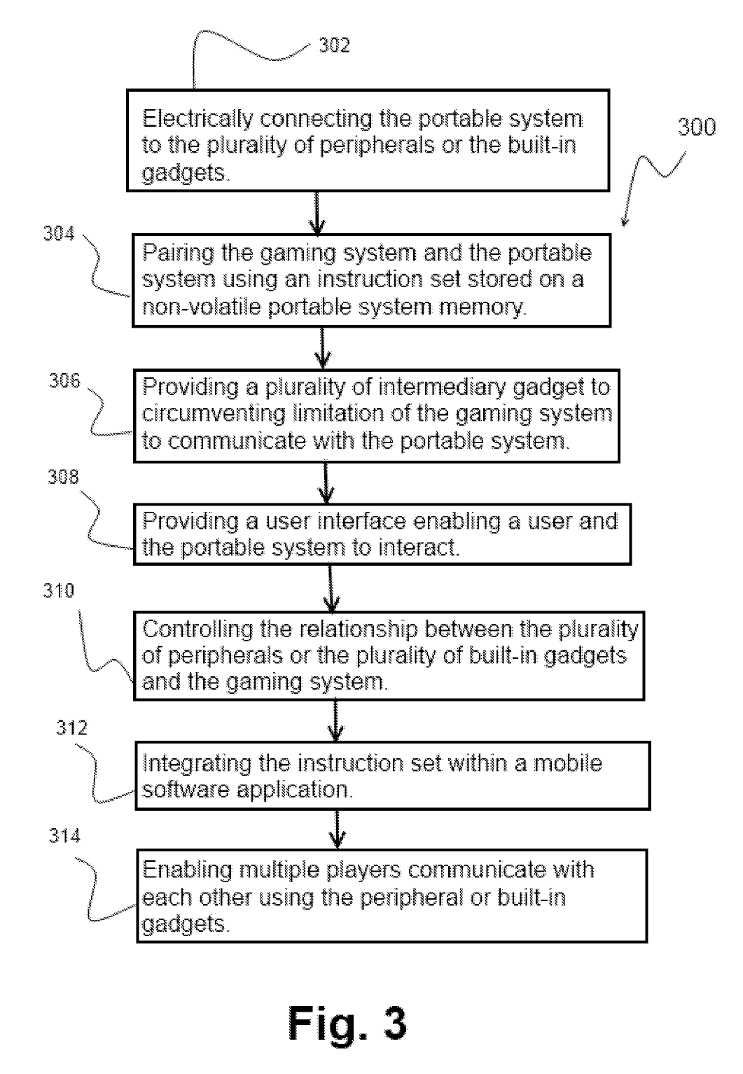

FIG. 3 illustrates a process/method 300 for enabling a portable system's peripherals or build-in gadgets to acts as gaming system 20 peripherals in accordance with an embodiment. The process 300 starts at 302 where the method involves electrically connecting the portable system 100 to the plurality of peripherals or the built-in gadgets. The method may also provide pairing the gaming system 20 and the portable system 100 using an instruction set stored on a non-volatile portable system memory, the instruction set further enabling pairing of the gaming system 20 with at least one of the portable system 100 peripherals or built-in gadgets.

The method may also include enabling communication of at least one of audio, visual, mechanical, sensory signals to and from the gaming system 20. The method may provide a user interface enabling a user and the portable system 100 to interact, such that the user interface uses the instruction set.

The method may further include managing the plurality of peripherals or the plurality of built-in gadgets using the user interface. The method may use the user interface for controlling the relationship between the plurality of peripherals or the plurality of built-in gadgets and the gaming system 20.

In one embodiment, the method may provide at least one of the peripheral or built-in gadgets as a headset with at least one speaker and a microphone built-in. The method integrating the instruction set within a mobile software application. The method pairing the portable system 100 with the gaming system 20 using one of a wired or wireless technology.

In addition, the method involves using the portable systems keypad to communicate instructions between the portable system 100 and the gaming system 20. The method further enabling multiple players communicate with each other using the peripheral or built-in gadgets.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A portable system for enabling the portable system's peripherals or built-in gadgets as gaming system peripherals, the portable system comprising:
the portable system enabled to electrically connect to the plurality of peripherals or the built-in gadgets; and
an instruction set, the instruction set stored on a non-volatile portable system memory, the instruction set coupling the gaming system and the portable system, enabling pairing of the gaming system with at least one of the portable system peripherals or built-in gadgets.

2. The system of claim 1 further comprising a plurality of intermediary gadgets, the plurality of intermediary gadget circumventing limitation of the gaming system to communicate with the portable system, the plurality of intermediary gadget enabling gaming system communicate with the portable system using the instruction set.

3. The system of claim 1, wherein the plurality of peripherals or the built-in gadgets enabling communication of at least one of audio, visual, mechanical, sensory signals to and from the gaming system via the portable system.

4. The system of claim 1 further comprising a user interface enabling a user and the portable system to interact, the user interface using the instruction set.

5. The system of claim 4, wherein the user interface providing controls for managing the plurality of peripherals or the plurality of built-in gadgets.

6. The system of claim 1, wherein at least one of the peripheral or built-in gadgets is a headset with at least one speaker and a microphone built-in.

7. The system of claim 1, wherein the instruction set is an integral part of a mobile software application.

8. The system of claim 1, wherein the portable system pairs with the gaming system using one of a wired or wireless technology.

9. The system of claim 1, wherein the portable systems keypad is used to communicate instructions between the portable system and the gaming system.

10. A method for enabling a portable system's peripherals or built-in gadgets to act as gaming system peripherals, the method comprising:
electrically connecting the portable system to the plurality of peripherals or the built-in gadgets; and
pairing the gaming system and the portable system using an instruction set stored on a non-volatile portable system memory, the instruction set further enabling pairing of the gaming system with at least one of the portable system peripherals or built-in gadgets.

11. The method of claim 10 further comprising providing a plurality of intermediary gadget, the plurality of intermediary gadget circumventing limitation of the gaming system to communicate with the portable system, the plurality of intermediary gadget enabling gaming system communicate with the portable system using the instruction set.

12. The method of claim 10 further comprising enabling communication of at least one of audio, visual, mechanical, sensory signals to and from the gaming system.

13. The method of claim 10 further comprises providing a user interface enabling a user and the portable system to interact, the user interface using the instruction set.

14. The method of claim 13, wherein managing the plurality of peripherals or the plurality of built-in gadgets is performed using the user interface.

15. The method of claim 13 further comprises using the user interface for controlling the relationship between the plurality of peripherals or the plurality of built-in gadgets and the gaming system.

16. The method of claim 10, wherein providing at least one of the peripheral or built-in gadgets as a headset with at least one speaker and a microphone built-in.

17. The method of claim 10, wherein integrating the instruction set within a mobile software application.

18. The method of claim 10, wherein pairing the portable system with the gaming system using one of a wired or wireless technology.

19. The method of claim 10, wherein using the portable systems keypad to communicate instructions between the portable system and the gaming system.

20. The method of claim 10, wherein enabling multiple players communicate with each other using the peripheral or built-in gadgets.
